(19) United States
(12) Patent Application Publication
(10) Pub. No.: US 2014/0223273 A1
(43) Pub. Date: Aug. 7, 2014

(54) MOBILE TERMINAL AND CONTROL METHOD THEREOF

(71) Applicant: LG ELECTRONICS INC., SEOUL (KR)

(72) Inventor: Saejoon CHUNG, SEOUL (KR)

(73) Assignee: LG ELECTRONICS INC., SEOUL (KR)

(21) Appl. No.: 14/098,186

(22) Filed: Dec. 5, 2013

(30) Foreign Application Priority Data
Feb. 6, 2013 (KR) 10-2013-0013469

(51) Int. Cl. G06F 17/22

(52) U.S. Cl. CPC G06F 17/2235
USPC 715/205

(57) ABSTRACT

The present disclosure relates to a mobile terminal capable of voice recognition and a control method thereof. The mobile terminal according to an embodiment includes a wireless communication unit configured to receive a first document written using a markup language from a server; a display unit; and a controller configured to: identify a hyperlink tag from at least one tag contained in the first document, generate a voice keyword for the hyperlink tag, the voice keyword to be used to access a second document associated with the hyperlink tag via a voice command, and control the display unit to display the voice keyword along with the first document.

### CROSS-REFERENCE TO RELATED APPLICATION

Pursuant to 35 U.S.C. §119(a), this application claims the benefit of earlier filing date and right of priority to Korean Application No. 10-2013-0013469, filed on Feb. 6, 2013, the contents of which is incorporated by reference herein in its entirety.

### BACKGROUND OF THE INVENTION

1. Field of the Invention

The present disclosure relates to a mobile terminal, and more particularly, to a mobile terminal capable of voice recognition and a control method thereof.

2. Description of the Related Art

Terminals can be classified into two types, such as a mobile or portable terminal and a stationary terminal based on its mobility. Furthermore, the mobile terminal can be further classified into two types, such as a handheld terminal and a vehicle mount terminal based on whether or not it can be directly carried by a user.

As the terminal becomes multifunctional, such a terminal is allowed to capture still images or moving images, play music or video files, play games, receive broadcast and the like, so as to be implemented as an integrated multimedia player. Moreover, the improvement of structural or software elements of the terminal may be taken into consideration to support and enhance the functions of the terminal.

Owing to the enhancement, a terminal may display a document written using a markup language on the display unit. At this time, markup denotes information added to a document to support the processing of the document. Markup information may include information on the format of a document such as the logical configuration or system of a document, or may include information on a connection relation (link) between contents contained in the document or on a connection relation to the content contained in another document. A language for expressing such markup information may be referred to as a markup language.

The markup language is a type of language that specifies the structure of data using a tag or the like. Here, the markup language may be configured with a series of elements (for example, tags) embedded in the document.

For representative markup languages, there are a Hypertext Markup Language (hereinafter, referred to as “HTML”) used in World Wide Web (WWW) homepages and a Standard Generalized Markup Language (hereinafter, referred to as “SGML) standardized by the International Standardization Organization (ISO).

Such a markup language may indicate the specific location of video, text, music, a photo, a program, a file or the like using a hyperlink. In other words, the markup language denotes a reference link capable of indicating or connecting to data in a document. The hyperlink may be simply referred to a link (or ring).

The hyperlink may be operated in a document using a hyperlink tag in the markup language. Here, the hyperlink tag may include a content (or a hypertext) having a link, where only this content is displayed to the user. As such, when a document is displayed on the display unit, the user can check the content related to the hyperlink tag, but cannot view the actual hyperlink tag itself.

In order to move to a document indicated by the hyperlink, it may be necessary for the user to manually select a content displayed by the hyperlink using a mouse or finger. For example, when the user clicks the content being displayed by the hyperlink using the mouse of a computer, a document indicated by the hyperlink may be displayed on the display unit of the computer.

### SUMMARY OF THE INVENTION

An object of the present disclosure is to provide a mobile terminal and a control method thereof for displaying a document indicated by a hyperlink using voice recognition.

In addition, another object of the present disclosure is to provide a mobile terminal and a control method thereof for providing a new user interface (UI) when content displayed by a hyperlink is selected using voice recognition.

In order to accomplish the foregoing tasks of the present disclosure, a mobile terminal according to an embodiment of the present invention may include a wireless communication unit configured to receive a first document written using a markup language from a server, a display unit configured to display the first document, and a controller configured to retrieve a hyperlink tag from tags contained in the first document, generate a voice keyword for the hyperlink tag to connect to a second document connected to the hyperlink tag with a voice command, and control the display unit to display the voice keyword along with the first document.

According to an embodiment, the mobile terminal may further include a microphone configured to receive a voice command corresponding to the voice keyword, wherein the controller displays the second document on the display unit when receiving a voice command corresponding to the voice keyword.

According to an embodiment, the controller may generate the voice keyword based on content displayed on the hyperlink tag.

According to an embodiment, the controller may generate the voice keyword using text when the content contains the text. Furthermore, the controller may generate the voice keyword using the description of the content contained in a tag for outputting the content when the content does not contain text. At this time, the description of the content may be information stated on at least one of the alt and title attributes of a tag for outputting the content.

According to an embodiment, the controller may generate the voice keyword using a numeral when the content does not contain text, and the tag for outputting the content does not contain the description of the content.

According to an embodiment, the controller may display a graphic object corresponding to the voice keyword at a location adjacent to the hyperlink tag.

According to an embodiment, the controller may generate a data structure containing the hyperlink of the second document and the voice keyword. At this time, the data structure may be a hash table in which the voice keyword is configured with a key, and the hyperlink with a hash value.

Furthermore, an embodiment of the present invention provides a control method of a mobile terminal The control method of the mobile terminal may include receiving a first document written using a markup language from a server, retrieving a hyperlink tag from tags contained in the first document, generating a voice keyword for the hyperlink tag to connect to a second document connected to the hyperlink tag with a voice command, and displaying the voice keyword along with the first document on the display unit.

According to an embodiment, the control method of the mobile terminal may further include displaying the second document on the display unit when receiving a voice command corresponding to the voice keyword.

According to an embodiment, the generating of the voice keyword may be generating the voice keyword based on content displayed on the hyperlink tag.

According to an embodiment, the generating of the voice keyword may include retrieving text contained in the content, and generating the voice keyword based on the content according to whether or not there exists the retrieved text.

According to an embodiment, the generating of the voice keyword may be generating the voice keyword using the retrieved text when there exists the retrieved text, or using the description of the content contained in a tag for outputting the content when there does not exists the retrieved text. At this time, the description of the content may be information stated on at least one of the alt and title attributes of a tag for outputting the content.

According to an embodiment, the generating of the voice keyword may be generating the voice keyword using a numeral when there does not exist the retrieved text, and the tag for outputting the content does not contain the description of the content.

According to an embodiment, the control method of the mobile terminal may further include displaying a graphic object corresponding to the voice keyword at a location adjacent to the hyperlink tag.

According to an embodiment, the control method of the mobile terminal may further include generating a data structure containing the hyperlink of the second document and the voice keyword. At this time, the data structure may be a hash table in which the voice keyword is configured with a key, and the hyperlink with a hash value.

According to an embodiment, the present invention provides a mobile terminal which includes a wireless communication unit configured to receive a first document written using a markup language from a server; a display unit; and a controller configured to: identify a hyperlink tag from at least one tag contained in the first document, generate a voice keyword for the hyperlink tag, the voice keyword to be used to access a second document associated with the hyperlink tag via a voice command, and control the display unit to display the voice keyword along with the first document.

According to an embodiment, the present invention provides a method of controlling a mobile terminal, the mobile including a display unit and a wireless communication unit, the method including: receiving, by the wireless communication unit, a first document written using a markup language from a server; identifying a hyperlink tag from at least one tag contained in the first document; generating a voice keyword for the hyperlink tag, the voice keyword to be used to access a second document associated with the hyperlink tag via a voice command; and displaying, on the display unit, the voice keyword along with the first document.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a mobile terminal according to an embodiment of the present invention;

FIGS. 2A and 2B are perspective views illustrating the external appearance of a mobile terminal associated with the present invention;

FIG. 3 is a flow chart illustrating a control method of a mobile terminal according to an embodiment of the present invention;

FIG. 4 is a flow chart illustrating a control method of a mobile terminal for receiving a voice command according to an embodiment of the present invention;

FIG. 5 is a conceptual view for explaining a mobile terminal according to the control method of FIGS. 3 and 4;

FIG. 6 is a flow chart illustrating a control method of a mobile terminal for generating a voice keyword according to an embodiment of the present invention;

FIG. 7 is a conceptual view for explaining the control method of FIG. 6;

FIG. 8 is a flow chart illustrating a control method of a mobile terminal for generating a data structure according to an embodiment of the present invention;

FIG. 9 is a conceptual view for explaining the data structure of FIG. 8; and

FIGS. 10 and 11 are exemplary views illustrating a mobile terminal according to an embodiment of the present invention.

### DETAILED DESCRIPTION OF THE PREFERRED EMBODIMENTS

Hereinafter, the embodiments of the present invention disclosed herein will be described in detail with reference to the accompanying drawings as examples only, and the same or similar elements are designated with the same numeral references regardless of the numerals in the drawings and their redundant description will be omitted. A suffix “module” or “unit” used for constituent elements disclosed in the following description is merely intended for easy description of the specification, and the suffix itself does not give any special meaning or function. In describing the embodiments disclosed herein, moreover, the detailed description will be omitted when a specific description for publicly known technologies to which the invention pertains is judged to obscure the gist of the present invention. Also, it should be noted that the accompanying drawings are merely illustrated to easily explain the concept of the invention, and therefore, they should not be construed to limit the technological concepts and features disclosed herein by the accompanying drawings.

A mobile terminal disclosed herein according to the embodiments of the present invention may include a portable phone, a smart phone, a laptop computer, a digital broadcast mobile device, a personal digital assistant (PDA), a mobile multimedia player (PMP), a navigation device, a slate PC, a tablet PC, an ultrabook, and the like. However, it would be easily understood by those skilled in the art that a configuration according to the following description may be applicable to a stationary terminal such as a digital TV, a smart TV, a work station, a desktop computer, and the like, excluding constituent elements particularly configured for mobile purposes.

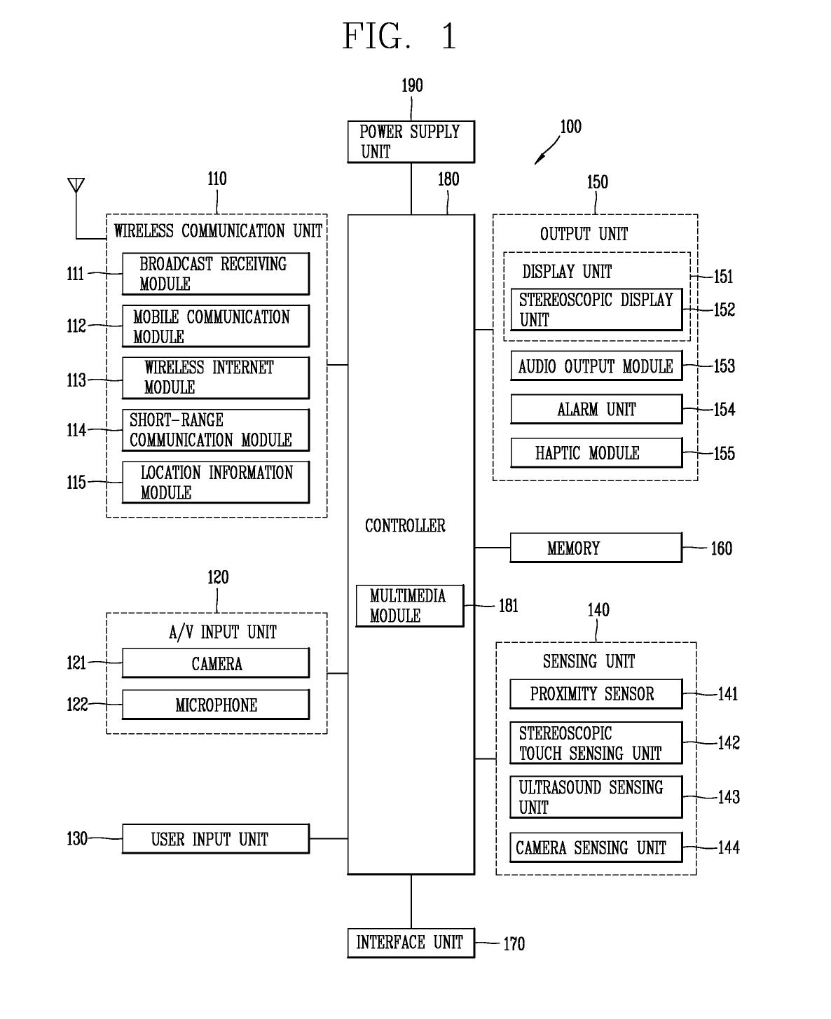

FIG. 1 is a block diagram illustrating a mobile terminal 100 according to an embodiment disclosed in the present invention.

The mobile terminal 100 may include a wireless communication unit 110, an audio/video (A/V) input unit 120, a user input unit 130, a sensing unit 140, an output unit 150, a memory 160, an interface unit 170, a controller 180, a power supply unit 190, and the like. However, one or more constituent elements as illustrated in FIG. 1 may not be necessarily required, and the mobile communication terminal may be implemented with a greater or less number of elements than those illustrated elements. All the components of the mobile terminal 100 or any other mobile terminal of the present invention described herein are operatively coupled and coupled.

Hereinafter, the foregoing constituent elements will be described in sequence.

The wireless communication unit 110 may include one or more modules allowing radio communication between the mobile terminal 100 and a wireless communication system, or allowing radio communication between the mobile terminal 100 and a network in which the mobile terminal 100 is located. For example, the wireless communication unit 110 may include at least one of a broadcast receiving module 111, a mobile communication module 112, a wireless Internet module 113, a short-range communication module 114, a location information module 115, and the like.

The broadcast receiving module 111 receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. Of course, the broadcast receiving module 111 may be configured to be suitable for every broadcast system transmitting broadcast signals as well as the digital broadcasting systems.

Broadcast signals and/or broadcast associated information received via the broadcast receiving module 111 may be stored in the memory 160.

The mobile communication module 112 transmits and receives wireless signals to and from at least one a base station, an external terminal and a server on a mobile communication network. Here, the wireless signals may include audio call signals, video call signals, or various formats of data according to the transmission and reception of text/multimedia messages.

The mobile communication module 112 may be configured to implement a video communication mode and a voice communication mode. The video communication mode refers to a configuration in which communication is made while viewing the image of the counterpart, and the voice communication mode refers to a configuration in which communication is made without viewing the image of the counterpart. The mobile communication module 112 may be configured to transmit or receive at least one of audio and video data to implement the video communication mode and voice communication mode.

The wireless Internet module 113 refers to a module for supporting wireless Internet access, and may be built-in or externally installed on the mobile terminal 100. Here, it may use a wireless Internet access technique including WLAN (Wireless LAN), Wi-Fi (Wireless Fidelity) Direct, DLNA (Digital Living Network Alliance), Wibro (Wireless Broadband), Wimax (World Interoperability for Microwave Access), HSDPA (High Speed Downlink Packet Access), and the like.

The short-range communication module 114 refers to a module for supporting a short-range communication. Here, it may use a short-range communication technology including Bluetooth™, Radio Frequency IDentification (RFID), Infrared Data Association (IrDA), Ultra WideBand (UWB), ZigBee, Near Field Communication (NFC) and the like.

The location information module 115 is a module for checking or acquiring the location of the mobile terminal, and there is a Global Positioning Module (GPS) module or Wireless Fidelity (WiFI) as a representative example.

Referring to FIG. 1, the A/V (audio/video) input unit 120 receives an audio and/or video signal, and the A/V (audio/video) input unit 120 may include a camera 121 and a microphone 122. The camera 121 processes image frames, such as still or moving images, obtained by an image sensor in a video phone call or image capturing mode. The processed image frame may be displayed on a display unit 151.

The image frames processed by the camera 121 may be stored in the memory 160 or transmitted to an external device through the wireless communication unit 110. Furthermore, the user's location information or the like may be produced from image frames acquired from the camera 121. Two or more cameras 121 may be provided according to the use environment.

The microphone 122 receives an external audio signal through a microphone in a phone call mode, a recording mode, a voice recognition mode, and the like, and processes the audio signal into electrical voice data. The processed voice data may be converted and outputted into a format that is transmittable to a mobile communication base station through the mobile communication module 112 in the phone call mode. The microphone 122 may implement various types of noise canceling algorithms to cancel noise generated in a procedure of receiving the external audio signal.

The user input unit 130 may generate input data to control an operation of the terminal The user input unit 130 may be configured by including a keypad, a dome switch, a touch pad (pressure/capacitance), a jog wheel, a jog switch, and the like.

The sensing unit 140 detects a current status of the mobile terminal 100 such as an opened or closed configuration of the mobile terminal 100, a location of the mobile terminal 100, a presence or absence of user contact with the mobile terminal 100, an orientation of the mobile terminal 100, an acceleration/deceleration of the mobile terminal 100, and the like, so as to generate a sensing signal for controlling the operation of the mobile terminal 100. For example, when the mobile terminal 100 is a slide phone type, the sensing unit 140 may sense whether a sliding portion of the mobile terminal is open or closed. Other examples include sensing functions, such as the sensing unit 140 sensing the presence or absence of power provided by the power supply unit 190, the presence or absence of a coupling between the interface unit 170 and an external device.

The output unit 150 is configured to generate an output associated with visual sense, auditory sense or tactile sense, and may include the display unit 151, an audio output module 153, an alarm unit 154, a haptic module 155, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call. When the mobile terminal 100 is in a video call mode or image capturing mode, the display unit 151 may display a captured image and/or received image, a UI or GUI.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, and an e-ink display.

Some of those displays may be configured with a transparent or optical transparent type to allow viewing of the exterior through the display unit, which may be called transparent displays. An example of the typical transparent displays may include a transparent LCD (TOLED), and the like. Under this configuration, a user can view an object positioned at a rear side of a mobile terminal body through a region occupied by the display unit 151 of the mobile terminal body.

Two or more display units 151 may be implemented according to a configured aspect of the mobile terminal 100. For instance, a plurality of the display units 151 may be arranged on one surface to be spaced apart from or integrated with each other, or may be arranged on different surfaces.

Furthermore, the display unit 151 may be configured with a stereoscopic display unit 152 for displaying a stereoscopic image. Here, stereoscopic image indicates a 3-dimensional stereoscopic image, and the 3-dimensional stereoscopic image is an image for allowing the user to feel the gradual depth and reality of an object located on the monitor or screen as in a real space. The 3-dimensional stereoscopic image may be implemented by using binocular disparity. Here, binocular disparity denotes a disparity made by the location of two eyes separated from each other, allowing the user to feel the depth and reality of a stereoscopic image when two eyes see different two-dimensional images and then the images are transferred through the retina and merged in the brain as a single image.

A stereoscopic method (glasses method), an auto-stereoscopic method (no-glasses method), a projection method (holographic method), and the like may be applicable to the stereoscopic display unit 152. The stereoscopic method primarily used in a home television receiver and the like may include a Wheatstone stereoscopic method and the like.

The examples of the auto-stereoscopic method may include a parallel barrier method, a lenticular method, an integral imaging method, and the like. The projection method may include a reflective holographic method, a transmissive holographic method, and the like.

In general, a 3-dimensional stereoscopic image may include a left image (image for the left eye) and a right image (image for the right eye). The method of implementing a 3-dimensional stereoscopic image can be divided into a top-down method in which a left image and a right image are disposed at the top and bottom within a frame, a left-to-right (L-to-R) or side by side method in which a left image and a right image are disposed at the left and right within a frame, a checker board method in which the pieces of a left image and a right image are disposed in a tile format, an interlaced method in which a left and a right image are alternately disposed for each column and row unit, and a time sequential or frame by frame method in which a left image and a right image are alternately displayed for each time frame, according to the method of combining a left image and a right image into a 3-dimensional stereoscopic image.

For 3-dimensional thumbnail images, a left image thumbnail and a right image thumbnail may be generated from the left and the right image of the original image frame, and then combined with each other to generate a 3-dimensional stereoscopic image. Typically, thumbnail denotes a reduced image or reduced still video. The left and right thumbnail image generated in this manner are displayed with a left and right distance difference on the screen in a depth corresponding to the disparity of the left and right image, thereby implementing a stereoscopic space feeling.

A left image and a right image required to implement a 3-dimensional stereoscopic image are displayed on the stereoscopic display unit 152 by a stereoscopic processing unit of the mobile terminal 100. The stereoscopic processing unit receives a 3D image to extract a left image and a right image from the 3D image, or receives a 2D image to convert it into a left image and a right image.

On the other hand, when the display unit 151 and a touch sensitive sensor (hereinafter, referred to as a “touch sensor”) have an interlayer structure (hereinafter, referred to as a “touch screen”), the display unit 151 may be used as an input device in addition to an output device. The touch sensor may be implemented as a touch film, a touch sheet, a touch pad, and the like.

The touch sensor may be configured to convert changes of a pressure applied to a specific part of the display unit 151, or a capacitance occurring from a specific part of the display unit 151, into electric input signals. The touch sensor may be configured to sense not only a touched position and a touched area, but also a touch pressure at which a touch object body is touched on the touch sensor. Here, the touch object body may be a finger, a touch pen or stylus pen, a pointer, or the like as an object by which a touch is applied to the touch sensor.

When there is a touch input to the touch sensor, the corresponding signals are transmitted to a touch controller. The touch controller processes the signal(s), and then transmits the corresponding data to the controller 180. Accordingly, the controller 180 may sense which region of the display unit 151 has been touched.

Referring to FIG. 1, a proximity sensor 141 may be arranged at an inner region of the mobile device 100 surrounded by the touch screen, or adjacent to the touch screen. The proximity sensor 141 may be provided as an example of the sensing unit 140. The proximity sensor 141 refers to a sensor to sense the presence or absence of an object approaching to a surface to be sensed, or an object disposed adjacent to a surface to be sensed, by using an electromagnetic field or infrared rays without a mechanical contact. The proximity sensor 141 has a longer lifespan and a more enhanced utility than a contact sensor.

The proximity sensor 141 may include an optical transmission type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, the proximity of an object having conductivity (hereinafter, referred to as a “pointer”) to the touch screen is sensed by changes of an electromagnetic field. In this case, the touch screen (touch sensor) may be categorized into a proximity sensor.

Hereinafter, for the sake of convenience of brief explanation, a behavior that the pointer is positioned to be proximate onto the touch screen without contact will be referred to as a “proximity touch”, whereas a behavior that the pointer substantially or directly comes in contact with the touch screen will be referred to as a “contact touch”. For the position corresponding to the proximity touch of the pointer on the touch screen, such position corresponds to a position where the pointer faces perpendicular to the touch screen upon the proximity touch of the pointer.

The proximity sensor 141 senses a proximity touch, and a proximity touch pattern (e.g., proximity touch distance, proximity touch direction, proximity touch speed, proximity touch time, proximity touch position, proximity touch moving status, etc.). Information relating to the sensed proximity touch and the sensed proximity touch patterns may be output onto the touch screen.

When the stereoscopic display unit 152 and a touch sensor are configured with an interlayer structure (hereinafter, referred to as a “stereoscopic touch screen”) or the stereoscopic display unit 152 and a 3D sensor for detecting a touch operation are combined with each other, the stereoscopic display unit 152 may be used as a 3-dimensional input device.

As an example of the 3D sensor, the sensing unit 140 may include a proximity sensor 141, a stereoscopic touch sensing unit 142, an ultrasound sensing unit 143, and a camera sensing unit 144.

The proximity sensor 141 measures a distance between the sensing object (for example, the user's finger or stylus pen) and a detection surface to which a touch is applied using an electromagnetic field or infrared rays without a mechanical contact. The terminal may recognize which portion of a stereoscopic image has been touched by using the measured distance. In particular, when the touch screen is implemented with a capacitance type, it may be configured such that the proximity level of a sensing object is sensed by changes of an electromagnetic field according to the proximity of the sensing object to recognize a 3-dimensional touch using the proximity level.

The stereoscopic touch sensing unit 142 may be configured to sense the strength or duration time of a touch applied to the touch screen. For example, stereoscopic touch sensing unit 142 senses a user applied touch pressure, and if the applied pressure is strong, then the stereoscopic touch sensing unit 142 recognizes it as a touch for an object located farther from the touch screen.

The ultrasound sensing unit 143 may be configured to sense the location of the sensing object using ultrasound. For example, the ultrasound sensing unit 143 may be configured with an optical sensor and a plurality of ultrasound sensors. The optical sensor may be formed to sense light, and the ultrasound sensor may be formed to sense ultrasound waves. Since light is far faster than ultrasound waves, the time for light to reach the optical sensor is far faster than the time for ultrasound waves to reach the ultrasound sensor. Accordingly, the location of the wave generating source may be calculated using a time difference between the light and ultrasound waves to reach the optical sensor.

The camera sensing unit 144 may include at least one of a camera 121, a photo sensor, and a laser sensor. For example, the camera 121 and laser sensor may be combined to each other to sense a touch of the sensing object to a 3-dimensional stereoscopic image. Distance information sensed by the laser sensor is added to a two-dimensional image captured by the camera to acquire 3-dimensional information.

For another example, a photo sensor may be deposited on the display element. The photo sensor may be configured to scan the motion of the sensing object in proximity to the touch screen. More specifically, the photo sensor is integrated with photo diodes and transistors in the rows and columns thereof, and a content placed on the photo sensor may be scanned by using an electrical signal that is changed according to the amount of light applied to the photo diode. In other words, the photo sensor performs the coordinate calculation of the sensing object according to the changed amount of light, and the location coordinate of the sensing object may be detected through this.

The audio output module 153 may output audio data received from the wireless communication unit 110 or stored in the memory 160, in a call-receiving mode, a call-placing mode, a recording mode, a voice recognition mode, a broadcast reception mode, and so on. The audio output module 153 may output audio signals relating to the functions performed in the mobile terminal 100 (e.g., sound alarming a call received or a message received, and so on). The audio output module 153 may include a receiver, a speaker, a buzzer, and so on.

The alarm unit 154 outputs signals notifying occurrence of events from the mobile terminal 100. The events occurring from the mobile terminal 100 may include call received, message received, key signal input, touch input, and so on. The alarm unit 154 may output not only video or audio signals, but also other types of signals such as signals notifying occurrence of events in a vibration manner. Since the video or audio signals can be output through the display unit 151 or the audio output unit 153, the display unit 151 and the audio output module 153 may be categorized into part of the alarm unit 154.

The haptic module 155 generates various tactile effects which a user can feel. A representative example of the tactile effects generated by the haptic module 154 includes vibration. Vibration generated by the haptic module 154 may have a controllable intensity, a controllable pattern, and so on. For instance, different vibration may be output in a synthesized manner or in a sequential manner.

The haptic module 155 may generate various tactile effects, including not only vibration, but also arrangement of pins vertically moving with respect to a skin being touched, air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 155 may be configured to transmit tactile effects through a user's direct contact, or a user's muscular sense using a finger or a hand. The haptic module 155 may be implemented in two or more in number according to the configuration of the mobile terminal 100.

The memory 160 may store a program for processing and controlling the controller 180. Alternatively, the memory 160 may temporarily store input/output data (e.g., phonebook, messages, still images, videos, and the like). Also, the memory 160 may store data related to various patterns of vibrations and sounds outputted upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the mobile terminal 100 may operate in association with a web storage which performs the storage function of the memory 160 on the Internet or other network.

The interface unit 170 may generally be implemented to interface the mobile terminal with external devices connected to the mobile terminal 100. The interface unit 170 may allow a data reception from an external device, a power delivery to each component in the mobile terminal 100, or a data transmission from the mobile terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

On the other hand, the identification module may be configured as a chip for storing various information required to authenticate an authority to use the mobile terminal 100, which may include a User Identity Module (UIM), a Subscriber Identity Module (SIM), and the like. Also, the device having the identification module (hereinafter, referred to as “identification device”) may be implemented in a type of smart card. Hence, the identification device can be coupled to the mobile terminal 100 via a port.

Furthermore, the interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals or power inputted from the cradle may operate as signals for recognizing that the mobile terminal 100 has accurately been mounted to the cradle.

The controller 180 preferably controls the overall operations of the mobile terminal 100. For example, the controller 180 performs the control and processing associated with telephony calls, data communications, video calls, and the like. The controller 180 may include a multimedia module 181 which provides multimedia playback. The multimedia module 181 may be configured as part of the controller 180 or as a separate component.

Furthermore, the controller 180 can perform a pattern recognition processing so as to recognize writing or drawing input carried out on the touch screen as text or image.

Furthermore, the controller 180 may implement a lock state for limiting the user's control command input to applications when the state of the mobile terminal satisfies a preset condition. Furthermore, the controller 180 may control a lock screen displayed in the lock state based on a touch input sensed through the display unit 151 in the lock state.

The power supply unit 190 receives external and internal power to provide power required for various components under the control of the controller 180.

Various embodiments described herein may be implemented in a computer or similar device readable medium using software, hardware, or any combination thereof.

For hardware implementation, it may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units designed to perform the functions described herein. In some cases, such embodiments may be implemented in the controller 180 itself.

For software implementation, the embodiments such as procedures or functions described in the present disclosure may be implemented with separate software modules. Each of the software modules may perform at least one function or operation described in the present disclosure.

Software codes can be implemented by a software application written in any suitable programming language. The software codes may be stored in the memory 160 and executed by the controller 180.

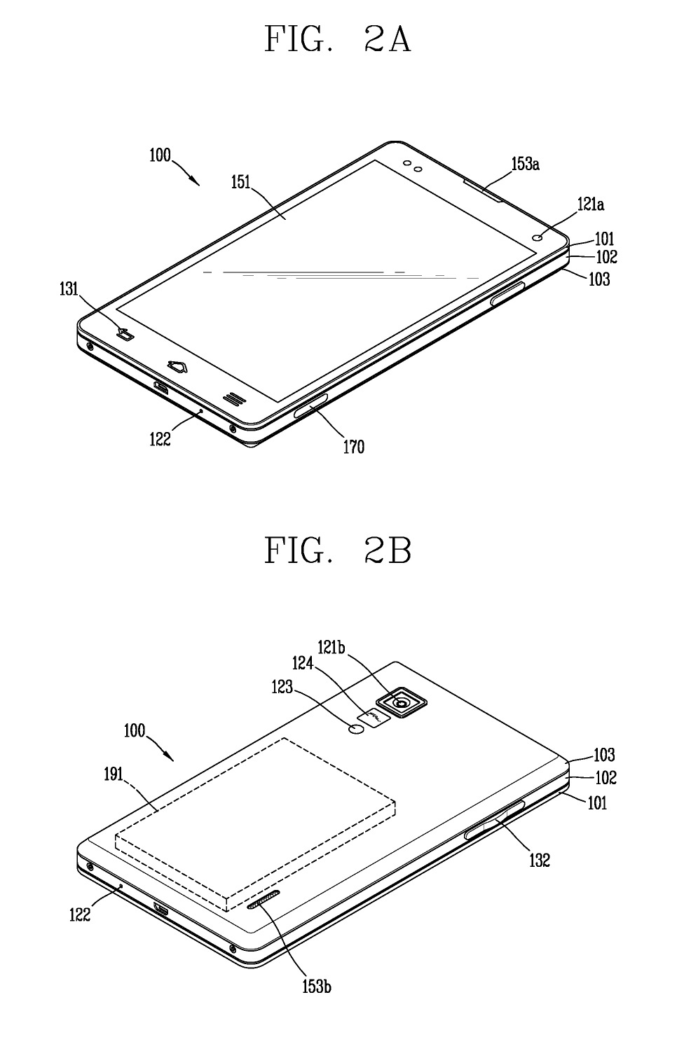

FIG. 2A is a front perspective view illustrating an example of the mobile terminal 100 associated with the present invention.

The mobile terminal 100 disclosed herein is provided with a bar-type terminal body. However, the present invention may not be limited to this, but also may be applicable to various structures and types such as watch type, clip type, glasses type or folder type, flip type, swing type, swivel type, or the like, in which two and more bodies are combined with each other in a relatively movable manner.

The body preferably includes a case (casing, housing, cover, etc.) forming the appearance of the terminal. In this embodiment, the case may be divided into a front case 101 and a rear case 102. Various electronic components are incorporated into a space formed between the front case 101 and the rear case 102. At least one middle case may be additionally disposed between the front case 101 and the rear case 102, and a battery cover 103 for covering the battery 191 may be detachably configured at the rear case 102.

The cases may be formed by injection-molding a synthetic resin or may be also formed of a metal, for example, stainless steel (STS), titanium (Ti), or the like.

The display unit 151, a first audio output module 153a, a first camera 121a, a first manipulating unit 131 and the like may be disposed on a front surface of the terminal body, and the microphone 122, the interface unit 170, a second manipulating unit 132 and the like may be provided on a lateral surface thereof.

The display unit 151 may be configured to display (output) information being processed in the mobile terminal 100. The display unit 151 may include at least one of a liquid crystal display (LCD), a thin film transistor-liquid crystal display (TFT-LCD), an organic light emitting diode (OLED) display, a flexible display, a 3-dimensional (3D) display, and an e-ink display.

The display unit 151 may include a touch sensing means to receive a control command by a touch method. When a touch is made to any one place on the display unit 151, the touch sensing means may be configured to sense this touch and enter the content corresponding to the touched place. The content entered by a touch method may be a text or numerical value, or a menu item capable of indication or designation in various modes.

The touch sensing means may be formed with transparency to allow visual information displayed on the display unit 151 to be seen, and may include a structure for enhancing the visibility of a touch screen at bright places. Referring to FIG. 2A, the display unit 151 occupies a most portion of the front surface of the front case 101.

The first audio output unit 153a and the first camera 121a are disposed in a region adjacent to one of both ends of the display unit 151, and the first manipulation input unit 131 and the microphone 122 are disposed in a region adjacent to the other end thereof. The second manipulation unit 132, the interface unit 170, and the like may be disposed on a lateral surface of the terminal body.

The first audio output module 153a may be implemented in the form of a receiver for transferring voice sounds to the user's ear or a loud speaker for outputting various alarm sounds or multimedia reproduction sounds.

It may be configured such that the sounds generated from the first audio output module 153a are released along an assembly gap between the structural bodies. In this case, a hole independently formed to output audio sounds may not be seen or hidden in terms of appearance, thereby further simplifying the appearance of the mobile terminal 100. However, the present invention may not be limited to this, but a hole for releasing the sounds may be formed on the window.

The first camera 121a processes video frames such as still or moving images obtained by the image sensor in a video call mode or capture mode. The processed video frames may be displayed on the display unit 151.

The user input unit 130 is manipulated to receive a command for controlling the operation of the mobile terminal 100. The user input unit 130 may include the first and second manipulation units 131, 132. The first and second manipulation units 131, 132 may be commonly referred to as a manipulating portion, and any method may be employed if it is a tactile manner allowing the user to perform manipulation with a tactile feeling such as touch, push, scroll or the like.

In the present drawing, it is illustrated on the basis that the first manipulation unit 131 is a touch key, but the present disclosure may not be necessarily limited to this. For example, the first manipulation unit 131 may be configured with a mechanical key, or a combination of a touch key and a mechanical key.

The content received by the first and/or second manipulation unit 131, 132 may be set in various ways. For example, the first manipulation unit 131 may be used to receive a command such as menu, home key, cancel, search, or the like, and the second manipulation unit 132 may receive a command, such as controlling a volume level being outputted from the first audio output module 153a, or switching into a touch recognition mode of the display unit 151.

The microphone 122 may be formed to receive the user's voice, other sounds, or the like. The microphone 122 may be provided at a plurality of places, and configured to receive stereo sounds.

The interface unit 170 serves as a path allowing the mobile terminal 100 to exchange data with external devices. For example, the interface unit 170 may be at least one of a connection terminal for connecting to an earphone in a wired or wireless manner, a port for near field communication (for example, an Infrared Data Association (IrDA) port, a Bluetooth port, a wireless LAN port, and the like), and a power supply terminal for supplying power to the mobile terminal 100. The interface unit 170 may be implemented in the form of a socket for accommodating an external card such as Subscriber Identification Module (SIM) or User Identity Module (UIM), and a memory card for information storage.

FIG. 2B is a rear perspective view illustrating the mobile terminal 100 illustrated in FIG. 2A.

Referring to FIG. 2B, a second camera 121b may be additionally mounted at a rear surface of the terminal body, namely, the rear case 102. The second camera 121b has an image capturing direction, which is substantially opposite to the direction of the first camera unit 121a (refer to FIG. 2A), and may have a different number of pixels from that of the first camera unit 121a.

For example, it is preferable that the first camera 121a has a relatively small number of pixels enough not to cause difficulty when the user captures his or her own face and sends it to the other party during a video call or the like, and the second camera 121b has a relatively large number of pixels since the user often captures a general object that is not sent immediately. The first and second cameras 121a, 121b may be provided in the terminal body in a rotatable manner.

Furthermore, a flash 123 and a mirror 124 may be additionally disposed adjacent to the second camera 121b. The flash 123 illuminates light toward an object when capturing the object with the second camera 121b. The mirror 124 allows the user to look at his or her own face, or the like, in a reflected way when capturing himself or herself (in a self-portrait mode) by using the second camera 121b.

A second audio output unit 153b may be additionally disposed at a rear surface of the terminal body. The second audio output unit 153b together with the first audio output unit 153a (refer to FIG. 2A) can implement a stereo function, and may be also used to implement a speaker phone mode during a phone call.

An antenna for receiving broadcast signals may be additionally disposed at a lateral surface of the terminal body in addition to an antenna for making a phone call or the like. The antenna constituting part of the broadcast receiving module 111 (refer to FIG. 1) may be provided in the terminal body in a retractable manner.

The power supply unit 190 (refer to FIG. 1) for supplying power to the mobile terminal 100 may be mounted on the terminal body. The power supply unit 190 may be incorporated into the terminal body, or may include a battery 191 configured in a detachable manner on the outside of the terminal body. According to the drawing, it is illustrated that the battery cover 103 is combined with the rear case 102 to cover the battery 191, thereby restricting the battery 191 from being released and protecting the battery 191 from external shocks and foreign substances.

Describing the controller 180 of the present invention again, the controller 180 may recognize voice received from the microphone 122, and analyze the recognized language. The controller 180 may identify a word or word string from a voice waveform received at the microphone 122 to extract the meaning thereof.

In other words, voice recognition denotes a function for analyzing a voice signal to combine it with a database that has been patterned, thereby converting it into a word string. The voice recognition may be carried out with five steps such as voice analysis, phoneme recognition, word recognition, sentence construction, and meaning extraction.

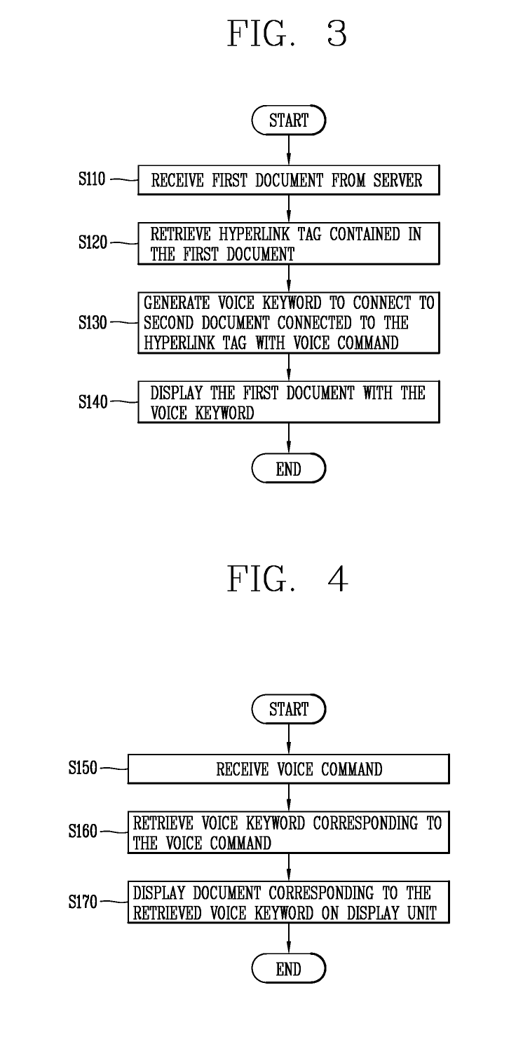

Here, a text string converted by the controller 180 using voice recognition may be referred to as a “voice command”. Hereinafter, a control method of a mobile terminal for displaying a document indicated by a hyperlink using a voice command on the display unit will be described below with reference to FIG. 3.

FIG. 3 is a flow chart illustrating a control method of a mobile terminal according to an embodiment of the present invention. The methods of the mobile terminal described herein in this embodiment and other embodiments can be implemented by the mobile terminal 100 or any other suitable devices.

Referring to FIG. 3, the control method of the mobile terminal according to an embodiment of the present invention may include the process (S110) of receiving a first document from a server. The terms or numbers possibly indicating an order such as first, second, and the like are used to merely distinguish objects different from one another, but do not determine the order of objects.

A first document denotes a document written using a markup language. For example, the first document may be a webpage document written using HTML. For another example, it may be a broadcast document displayed on a television (or TV) through a set-top box.

The markup language has been described above in the description of the background of the invention and thus the description thereof will be omitted. However, the markup language will not be limited to embodiments disclosed in the present disclosure, which may include, e.g., SGML, HTML, dynamic hypertext markup language (HTML), extensible markup language (XML) and the like.

The server is configured to communicate with the mobile terminal using any of the known techniques, and may be formed to store documents written with such a markup language and receive data for the documents.

The mobile terminal may use a uniform resource locator (hereinafter, referred to as “URL”) indicating at least one location (e.g., location of the server, area, document etc.) to receive at least one of the documents stored in the server. For example, the controller 180 may access a predetermined URL using the wireless communication unit 110 to receive a document located at the predetermined location/document.

Next, the process (S120) of analyzing the received first document and retrieving/identifying a hyperlink tag contained in the first document may be carried out. At this time, the first document may include at least one hyperlink tag. After analyzing each hyperlink tag in the first document, the controller 180 may select automatically at least one hyperlink tag desired to generate a voice keyword for the same hyperlink tag.

The hyperlink tag denotes a tag for making a hyperlink, and denotes, e.g., a tag “<a>” in HTML. “<a href=‘Content ‘</a>’ desired to be displayed using a hyperlink tag URL’>’ indicating the location of a document desired to be connected” may be an example of hyperlink tag. However, what is displayed on the display unit 151 is a content representing the hyperlink tag, but not the exact hyperlink tag itself.

The hyperlink tag may include location information of a document desired to be connected and/or of a content desired to be displayed. The location information of the document desired to access may be a URL, for example.

Contents denote all objects that are displayable on the display unit 151 of the mobile terminal 100. For example, the contents may be a menu icon for selecting a function that can be implemented in the mobile terminal 100 or a multimedia icon for reproducing video data or music data that can be reproduced in the mobile terminal 100, an image displayed in the mobile terminal 100, a thumbnail image for displaying a high-capacity image or video, a data name set to each of various data, and the like. Furthermore, the contents may be displayed as an image, text or the like. In other words, the contents may include at least one of text, a photo, music, a moving image, audio, video and flash.

Next, the process (S130) of identifying and generating a voice keyword representing the selected hyperlink tag, which will be used to connect to a second document connected to the selected hyperlink tag with a voice command may be carried out. The hyperlink tag may indicate and refers to the second document different from the first document. In other words, when a designated content (designated voice keyword) displayed and representing a hyperlink tag contained in the first document is selected by the user who selects or speaks the designated voice keyword, the controller 180 may display the second document on the display unit 151 since the second document is retrievable by the hyperlink tag associated with the designated voice keyword. At this time, the second document may be displayed instead of the first document, or the first document may be displayed with the second document at the same time on the same screen of the mobile terminal. In the latter case, if the user selects a different designated voice keyword in the first document via a voice command, then a third document associated with the different designated voice keyword will be displayed simultaneously with the first document on the same screen. Since the first document is always displayed and readily accessible, this allows the user to easily switch to different documents/contents using the first document without having to switch back to the first document.

The controller 180 may automatically designate and generate a voice keyword for the selected hyperlink tag, which will then be used subsequently by the user to select a second document with a voice command. For example, a word “CLICK” may be designated and generated automatically by the controller 180 as a voice keyword representing the hyperlink tag connected to the second document. If so, when a voice command “CLICK” is received from the user (e.g., the user speaking the word “CLICK” to the mobile terminal) while the first document is displayed on the screen of the mobile terminal, the controller 180 displays the second document corresponding to voice command “CLICK”.

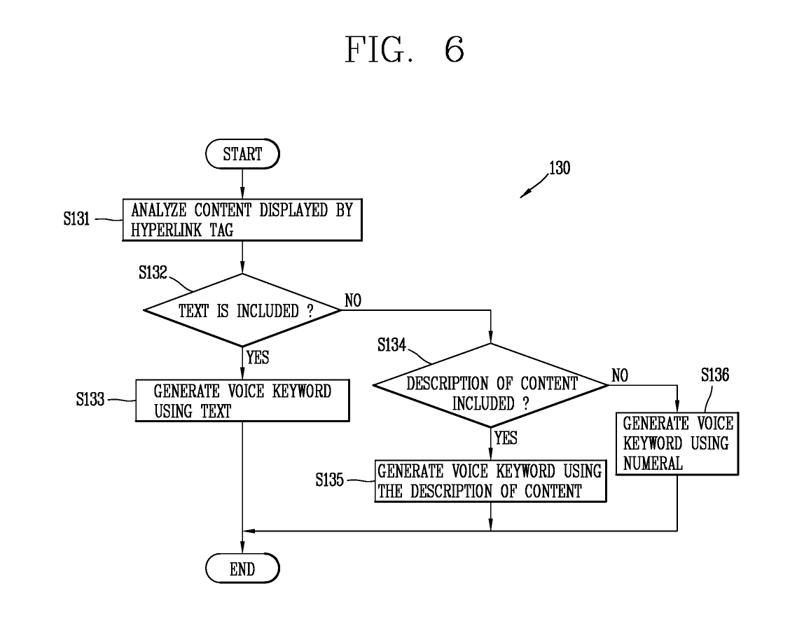

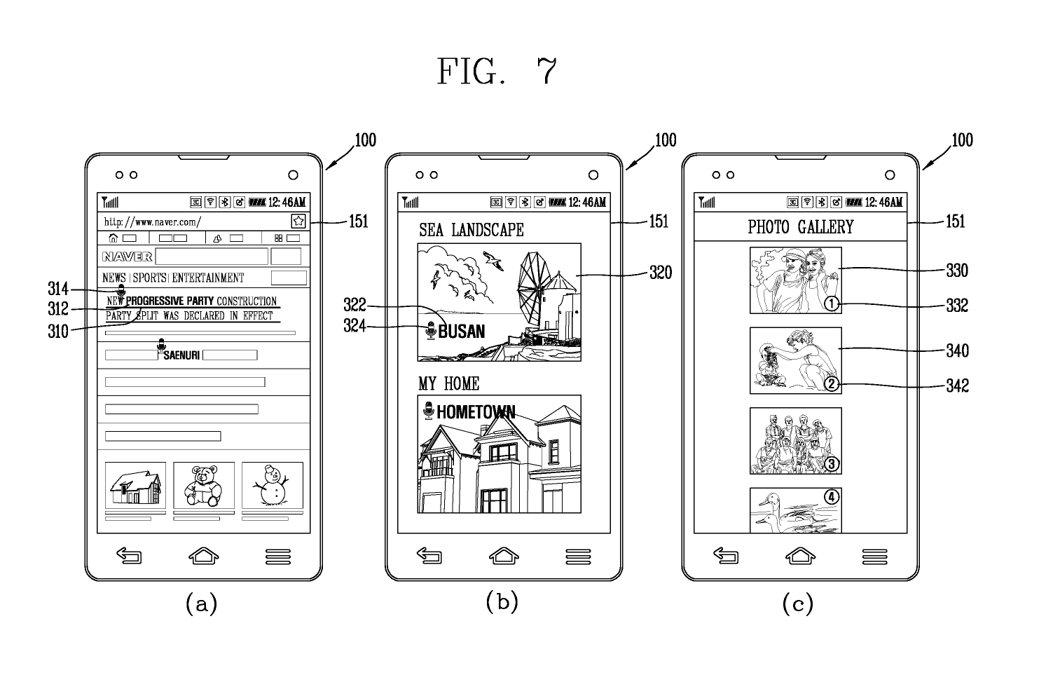

The controller 180 may generate a voice keyword using various methods. For instance, the controller 180 may designate a specific word, content or text included in a representative content representing and displayed by a hyperlink tag, as the voice keyword for triggering the hyperlink tag. The voice keyword may be generated as a word within four characters to enhance the accuracy of the voice command. The descriptions related to a control method of a mobile terminal for generating a voice keyword will be described later with reference to FIGS. 6 and 7.

Next, in the method of FIG. 3, the process (S140) of displaying the designated/generated voice keyword along with the first document on the same screen of the display unit 151 will be carried out. The controller 180 may display the voice keyword along with the first document when displaying the first document received from the server on the screen.

For example, the controller 180 may display contents or image displayed by a hyperlink to be overlapped with the voice keyword. For another example, when the voice keyword is contained in the content/image, a marker pen effect may be added to a portion corresponding to the voice keyword when displaying the content/image.

Furthermore, the controller 180 may display a graphic object corresponding to the designated voice keyword at a location adjacent to the hyperlink tag on the screen. The graphic object refers to a graphic element used to distinguish the designated voice keyword from other contents displayed in the first document. For example, a microphone image or other icon image may be displayed as the graphic object to remind the user that the user can use a voice to trigger the designated voice keyword, which in turn will cause displaying of the second document connected to the hyperlink tag associated with the designated voice keyword.

In one example, when the first document contains a plurality of hyperlink tags, the controller 180 may generate a plurality of voice keywords. At this time, the voice keywords my respectively correspond to different hyperlink tags contained in the same first document. The controller 180 may generate voice keywords for all the hyperlink tags or generate voice keywords corresponding to a predetermined number.

FIG. 4 is a flow chart illustrating a control method of a mobile terminal for receiving a voice command according to an embodiment of the present invention. The control method of the mobile terminal illustrated in FIG. 4 presupposes the control method illustrated in FIG. 3. In other words, it illustrates the control method of the mobile terminal for receiving a voice command in a state that the first document and the voice keyword are displayed at the same time at the end of step S140 in FIG. 3.

Referring to FIG. 4, the control method of the mobile terminal for receiving a voice command according to an embodiment of the present invention may include the process (S150) of receiving a voice command from the user of the mobile terminal to the mobile terminal. When a voice is received by the microphone 122 of the mobile terminal, the controller 180 may perform voice recognition for the received voice, and determine it as receiving a voice command. In this regard, in one embodiment, at the end of step S140, the mobile terminal may enter automatically into a voice command recognition mode for readily recognizing a voice command for the designated voice keyword. In another example, the user may first select the mobile terminal to enter the voice command recognition mode before speaking the designated voice keyword to the mobile terminal.

Next, the process (S160) of identifying and retrieving a voice keyword corresponding to the voice command may be carried out, and then the process (S170) of displaying a document or other content corresponding to the retrieved voice keyword on the display unit may be carried out.

The controller 180 may identify a specific voice keyword that matches the received voice command. In other words, when a plurality of voice keywords are designated and displayed in the first document, any one voice keyword corresponding to the received voice command is retrieved. For example, “2” and “3” may be designated as a voice keyword for the second document and a voice keyword for the third document, respectively. When “3” is received as a voice command (e.g., when the user speaks “3” to the mobile terminal), the controller 180 may recognize that the voice keyword “3” matches the “3” voice command, and in turn display the third document corresponding to the recognized “3” voice keyword on the display unit 151.

As described above, according to the present invention, when displaying the first document, the mobile terminal 100 may display a voice keyword for a hyperlink tag indicating the second document along therewith, and thus the user can visually identify what the voice keyword is and access the desired second document using a voice command (e.g., by speaking the identified voice keyword to the mobile terminal). As a result, the user may display the second document by merely speaking the voice keyword, thereby using the hyperlink in a convenient method.

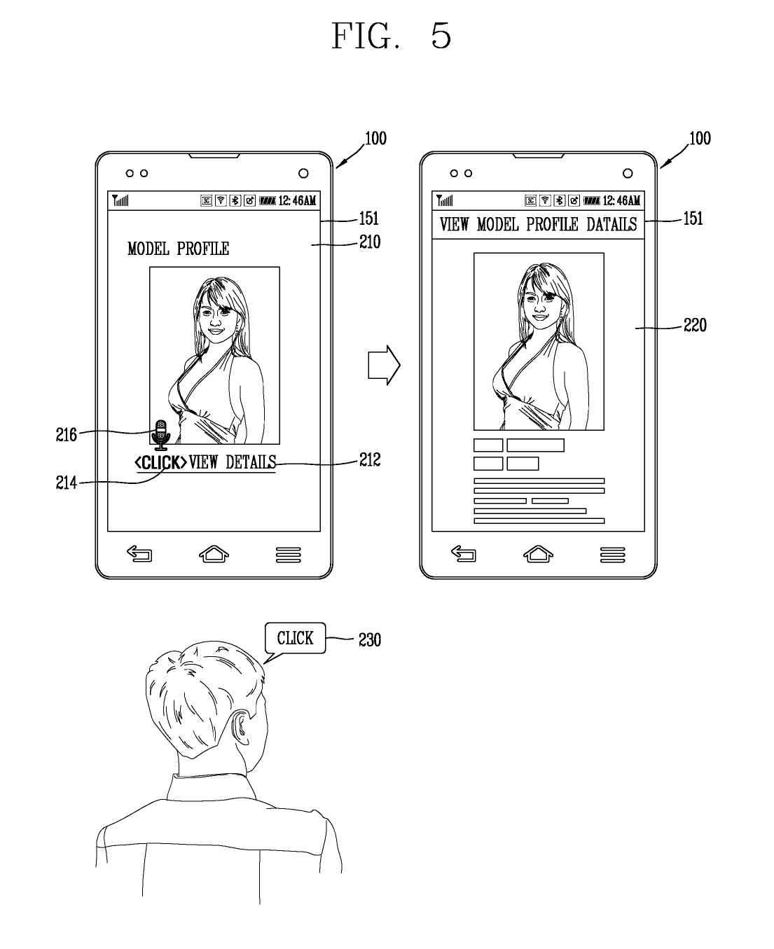

FIG. 5 is a conceptual view for explaining an operation of a mobile terminal according to an example of the control method of FIGS. 3 and 4.

Referring to FIG. 5, the mobile terminal 100 may include the display unit 151 configured to display at least one of a first document 210 and a second document 220. The first and the second document 210, 220 are documents written by a markup language. Here, the documents are used only as mere examples, and they can be other types of any contents.

Prior to displaying the first document, the controller 180 generates a voice keyword (“CLICK”) 214 for audibly selecting a content (“VIEW DETAILS”) displayed by or representing a hyperlink 212 associated with the second document 220. In one example, the content representing the hyperlink 212 may include the voice keyword so that such content may be equal to ““<CLICK>VIEW DETAIL”. Then the first document 210 including the content (“VIEW DETAILS”) displayed by or representing the hyperlink tag 212 is displayed, wherein such content may be underlined or displayed with a different color (particularly, blue) from the other portion within the first document 210.

In more details as shown in FIG. 5, it is seen that the content “<CLICK>VIEW DETAILS” is displayed by the hyperlink tag 212, which represents the hyperlink tag 212. For example, the controller 180 may select the word “CLICK” 214 as a voice keyword for the hyperlink tag 212. Here, preferably the controller 180 automatically selects by itself (without any user input) the word “CLICK” 214 as the ‘voice keyword’ for the displayed hyperlink tag.

The controller 180 of the mobile terminal 100 according to the present invention then displays the designated or generated voice keyword 214 along with the first document 210. At this time, the display unit 151 can be controlled to highlight the designated voice keyword 214 so that the user can recognize what the voice keyword is for the hyperlink tag 212. For example, referring to FIG. 5, it is seen that “CLICK” 214 in the voice keyword is displayed to be distinguished from other portion of the content representing the hyperlink tag 212 and/or the other portion of the first document 210.

Moreover, the controller 180 may display a graphic object 216 corresponding to the voice keyword 214 at a location adjacent to the hyperlink tag 212. The graphical object 216 reminds the user to use a voice command to activate the hyperlink tag 212. As a result, intuitive power for the voice keyword may be enhanced.

When the first document 210 is displayed as shown in FIG. 5, the mobile terminal 100 may receive a voice command 230 from the user. The controller 180 may then recognize and retrieve a voice keyword that matches the voice command. That is, the controller 180 recognizes that the user has selected the voice keyword “CLICK” using the user's voice. Then, the controller 180 may display a document or other content associated with the recognized voice keyword on the display unit 151. For example, when a word “CLICK” is received as a voice command 230 from the user of the mobile terminal, the mobile terminal recognizes it as the voice command to select the “CLICK” keyword 214 for the hyperlink 212. Then the mobile terminal retrieves the second document 220 associated with the hyperlink tag 212 corresponding to the selected “CLICK” voice keyword 214 and displays it on the display unit 151. As a result, the user can easily access desired information and contents by merely using voice commands.

Though it is illustrated in FIG. 5 that the first document 210 contains one voice keyword 214, the first document 210 may include a plurality of hyperlink tags respectively associated with a plurality of voice keywords. Accordingly, a plurality of different voice keywords may be also displayed simultaneously in association with a plurality of different hyperlinks on the display unit 151. The user can return to the first document 210 at any time to trigger a different voice keywords among the plurality of voice keywords contained in the first document 210.

FIG. 6 is a flow chart illustrating a control method of a mobile terminal for generating a voice keyword according to an embodiment of the present invention. FIG. 6 is a flow chart for more specifically explaining an example of the foregoing process (S130) of generating a voice keyword with reference to FIG. 3.

Referring to FIG. 6, the process (S130) of generating a voice keyword may include the process (S131) of extracting and analyzing a content to be displayed by or representing a hyperlink tag. Next, the process (S132) of analyzing whether or not the extracted content includes a text may be carried out.

When the extracted content includes a text, the process (S133) of generating a voice keyword using the same text or a portion thereof is carried out. The controller 180 may set any one or more of words contained in the extracted text as the voice keyword. For example, a first word of the text or a word which is most frequently contained in the text may be set as the voice keyword. For another example, the voice keyword may be set as a word which has been previously set by a server manager or the like. For instance, in the example of FIG. 5, the word “CLICK” is set as the voice keyword for the content “VIEW DETAILS” representing the hyperlink tag 212.

When the extracted content itself does not contain any text but contains a description of the content (e.g., in another tag associated with the extracted content), the process (S135) of generating a voice keyword using the description of the content may be carried out. For example, a content representing a hyperlink tag in HTML may be determined by a tag entered between tags “<a>” and </a>″. Hereinafter, a tag for displaying the content may be referred to as a “content tag”.

The content tag may include at least one of an image tag (<image>), an object tag (<object>), a video tag (<video>), an audio tag (<audio>), a video or flash tag (<embed>), an article Tag (<article>), and a navigation tag (<nav>).

The controller 180 may generate a voice keyword using a content contained in the content tag associated with the hyperlink tag. In particular, the controller 180 may use contents described in at least one of the alt and title attributes of the content tag associated with the hyperlink tag. Here, the alt attribute is used in the image tag, which is information displayed on the display unit when a picture cannot be rendered. The title attribute is information used to specify the title of content.

When the extracted content itself does not contain any text as well as the description of the content, the process (S136) of generating a voice keyword using a numeral may be carried out. When any specific text or description for the hyperlink tag may not be obtainable, the controller 180 may generate a voice keyword for the hyperlink tag using a numeral. For example, when “1” and “2” have been previously generated as voice keywords, “3” may be generated as a voice keyword. In other words, when there exist a plurality of hyperlink tags which are not directly associated with any specific text, description or information for generating a voice keyword, the voice keywords for such hyperlink tags can be generated by designating numbers thereto, e.g., as sequentially increasing numbers.

As described above, according to the embodiments of the present invention, voice keywords can be generated in a systematic method, thereby providing intuitive voice keywords to the user.

FIG. 7 is a conceptual view for explaining an example of the control method of FIG. 6.

Referring to FIGS. 7(a), 7(b) and 7(c), the mobile terminal 100 according to examples of the present invention may include the display unit 151 for displaying a voice keyword along with a document.

Referring to a first example in FIG. 7(a), a first hyperlink tag 310 may be represented by a first content such as “NEW PROGRESSIVE PARTY CONSTRUCTION . . . PARTY SPLIT WAS DECLARED IN EFFECT”. Since the first content includes texts, the controller 180 then generates a voice keyword using the texts or a portion thereof. For example, the voice keyword may be generated using at least one of “new”, “progressive party”, “construction”, “party split”, “was declared” and “in effect”.

Due to the development of voice recognition technologies, it may be possible to distinguish the word or distinguish the type of word (for example, verb or noun). Accordingly, a noun contained in text may be used to promote the user's convenience and enhance the efficiency of voice recognition. Furthermore, a noun corresponding to two through four characters may be used for a voice keyword. In addition, a word relatively located at the beginning of words contained in the text to improve the speed of retrieval.

Referring to FIG. 7(a), “PROGRESSIVE PARTY” may be designated and displayed as a first voice keyword 312 for the first hyperlink tag 310 according to the foregoing condition. At this time, a graphic object 314 corresponding to the first voice keyword 312 may be displayed at the same time. Then according to the method described above, when the user speaks the first voice keyword 312, a document or content associated with the first voice keyword 312 will be displayed to the user.

Referring to a second example in FIG. 7(b), a second hyperlink tag 320 may be represented by a second content formed with an image file such as a photo of a sea scene. Since the second content is the photo of the sea scene, it does not include any text, and thus the controller 180 may retrieve a description of the second content as a voice keyword as in step S135 of FIG. 6.

More specifically, though not displayed on the display unit 151, it is assumed that information “off the coast of Busan” is stated in the alt attribute of an image tag of the second content. In this case, the controller 180 may generate “Busan” (which is part of the description of the second content as contained in the image tag) as a second voice keyword 322, and display the generated voice keyword 322 on the display unit 151. A second graphic object 324 corresponding to the second voice keyword 322 may be also displayed thereon to remind the user to use a voice command to trigger the second hyperlink tag 320.

Referring to a third example in FIG. 7(c), the mobile terminal 100 in which four photos are displayed on the display unit 151 is illustrated. The four photos are contents displayed by or representing different hyperlink tags, respectively, and it is assumed that any text or the description of content is not contained therein.

In this case, the controller 180 may generate a voice keyword using a numeral as in step S136 of FIG. 6. For example, the controller 180 may generate “one” as a third voice keyword 332 for a third hyperlink tag 330 since the third hyperlink tag 330 is at the first location, and generate “two” as a fourth voice keyword 342 for a fourth hyperlink tag 340 since the fourth hyperlink tag 340 is at the second location. If a voice command “two” is received, then the controller 180 may display a document indicated by the fourth hyperlink tag 340 on the display unit 151.

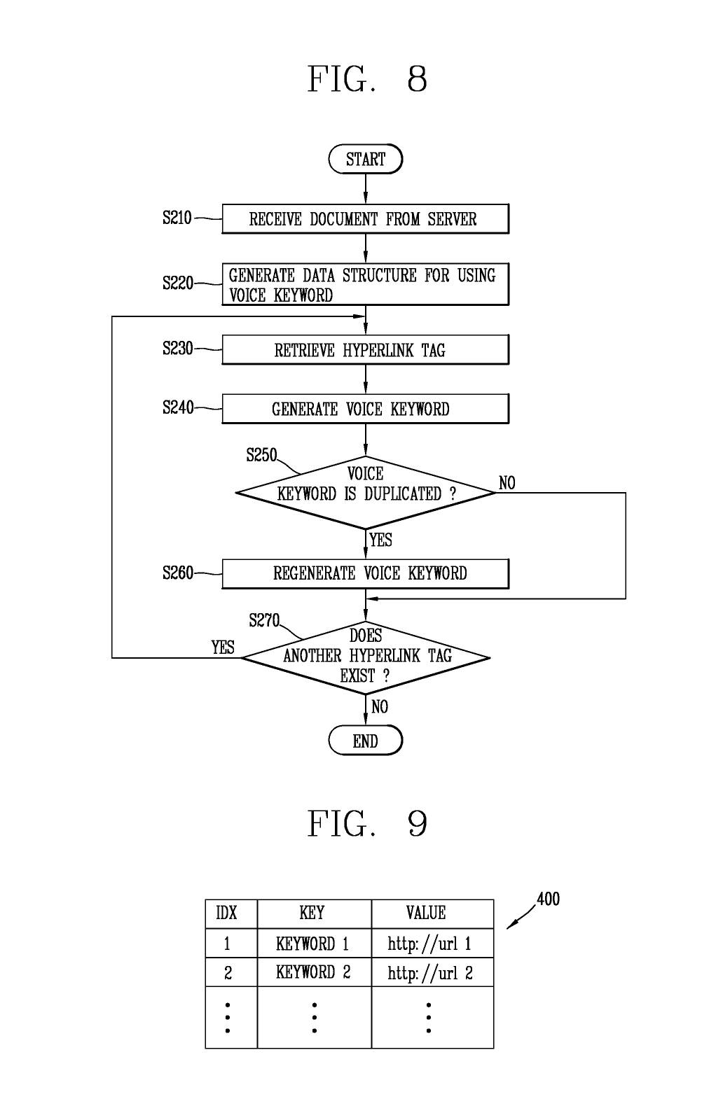

FIG. 8 is a flow chart illustrating a control method of a mobile terminal for generating a data structure according to an embodiment of the present invention.

Referring to FIG. 8, the control method of the mobile terminal for generating a data structure according to an embodiment of the present invention may be performed by the mobile terminal. The control method may include the process (S210) of receiving a document from a server communicating with the mobile terminal. Next, the process (S220) of generating a data structure to use a voice keyword may be carried out.

A document received from the server may include at least one hyperlink tag. At this time, the controller 180 may generate a data structure for managing voice keywords to effectively manage the voice keywords. For the data structure, a hyperlink and a voice keyword corresponding to the hyperlink may be stored in a table structure. For the speed of retrieval, the controller 180 may store a data structure in the memory of the mobile terminal.

Next, the process (S230) of retrieving a hyperlink tag may be carried out. The controller 180 may analyze the document received from the server in the unit of line, and analyze the tags of each line to determine whether or not a hyperlink tag is contained therein.

When the hyperlink tag is determined to be present and retrieved, then the process (S240) of generating a voice keyword may be carried out. Next, the process (S250) of determining whether or not the current voice keyword is a duplicate. The controller 180 may determine whether or not the generated voice keyword is a duplicate of another existing voice keyword using the generated data structure. For example, when a voice keyword “one” is stored in the data structure along with a hyperlink “first url”, the voice keyword “one” may not be used again for a different voice keyword so as to avoid generation of voice keywords in a duplicated manner.

When the controller recognizes that the currently generated voice keyword is a duplicate (i.e., the same voice keyword exists in the store table), the process (S260) of regenerating a new voice keyword may be carried out. The controller 180 may add a numeral to the duplicated voice keyword to control the voice keyword from being duplicated. For example, numeral “one” is added to “one” in the foregoing example to generate a new voice keyword “one-one” different from the existing voice keyword “one” stored in the table. The numeral for preventing redundancy may be sequentially increased or any other techniques may be used to generate a different voice keyword. In other words, when a voice keyword “one” is generated again after that, numeral “two” may be added to “one” to generate a new voice keyword “one-two”. As a result, the mobile terminal updates the table (data structure) to include the newly retrieved hyperlink tag in association with the newly regenerated voice keyword.

Next, the process (S270) of determining whether or not there exists another hyperlink tag in the document may be carried out. If the mobile terminal determines that there exists another hyperlink tag for which a voice keyword has not be designated or generated, it may return to the process (S230) to assign a new voice keyword for that hyperlink tag. These processes may be repeated until all of the hyperlink tags in the document are assigned with voice keywords.

FIG. 9 is a conceptual view for explaining an example of the data structure discussed in step S220 of FIG. 8.

Referring to FIG. 9, a data structure 400 in one example may be generated using the foregoing control method with reference to FIG. 8. In particular, the data structure 400 may be a hash table in which each voice keyword is configured with a key, and the corresponding hyperlink with a hash value. The hyperlink may be a uniform resource locator (URL), for example.

As described above, once the data structure are generated and updated as needed to include all the generated voice keywords used in the mobile terminal according to the embodiments of the present invention, it may be possible perform a quick response to a voice command using the data structure. Furthermore, it may be possible to prevent a voice keyword from being generated in a duplicated manner.

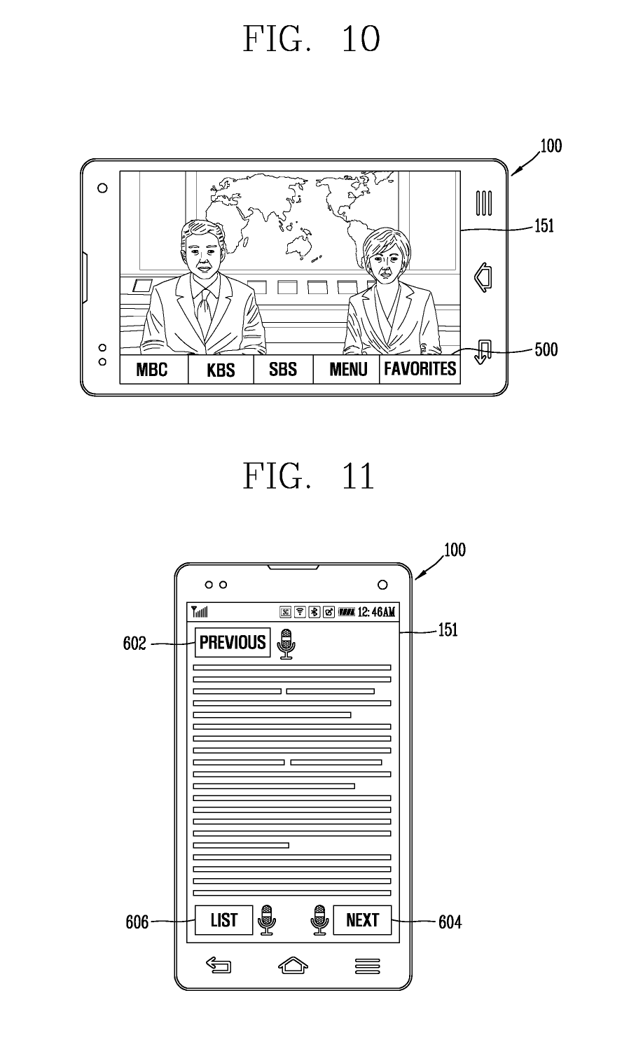

FIGS. 10 and 11 are exemplary views illustrating a mobile terminal according to an embodiment of the present invention.

Referring to FIG. 10, the mobile terminal 100 in which a real-time broadcast is displayed on the display unit 151 is illustrated. The controller 180 may allow a menu 500 associated with a broadcast channel to be written with a markup language to display it on the display unit 151. For example, the first hyperlink tag may display a content “MBC” and the second hyperlink tag may display a content “KBS”. Furthermore, when the user enters a touch to the first hyperlink tag, the controller 180 may display a real-time broadcast associated with “MBC” on the display unit 151.

At this time, the controller 180 may generate voice keywords for hyperlink tags contained in each menu, and display the generated voice keywords on the display unit 151. For example, when a voice command “MBC” is received, the controller 180 may display a real-time broadcast associated with “MBC” on the display unit 151.

Referring to FIG. 11, the mobile terminal 100 including the display unit 151 for displaying a page according to the execution of an application is illustrated.

The page displayed according to the execution of an application may be also a document written using a markup language. For example, the user may click an icon corresponding to “previous” or “next” to move the page in the application associated with books.

When the page is written using a markup language, the controller 180 may generate a voice keyword 602, 604 for at least one of “previous” and “next” menu icons, and display the generated voice keyword on the display unit 151. Furthermore, the controller 180 may display a voice keyword 606 for a “list” menu icon on the display unit 151. In addition, the controller 180 may display a graphic object corresponding to the voice keyword. As such, the voice keywords can be designated and used for any selectable menu items.

A mobile terminal and a control method thereof according to the embodiments of the present invention may be applicable to all applications for displaying a document or content using a markup language as well as applications associated with books or others.

As described above, according to the embodiments of the present invention, a voice keyword for a hyperlink tag may be generated in a document or content written by a markup language, and thus a hyperlink can be linked with a voice command, but if desired, may not be linked with a touch or click made by the user using a finger, mouse or stylus.

According to the embodiments of the present invention, a document or content associated with a hyperlink may be displayed using a voice command, and thus the user can use the mobile terminal using a new method and not using a click or touch made by the user using a finger, mouse or stylus.

Furthermore, according to the embodiments of the present invention, a voice keyword corresponding to the hyperlink may be displayed along with a document, and thus the user can check a usable voice command using the voice keyword.

Furthermore, according to the embodiments of the present invention, voice keywords may be generated based on a content representing the hyperlink, thereby presenting intuitive voice keywords to the user.

Furthermore, according to the embodiments of the present invention, when a document generated by a markup language is received, a hash table associated with the hyperlinks and voice keywords may be generated, thereby allowing the mobile terminal to quickly retrieve a voice keyword in response to a voice command.

While the invention has been shown and described with respect to various embodiments of the present invention, it will be of course understood by those skilled in the art that various modifications may be made without departing from the gist of the invention as defined in the following claims, and it is to be noted that those modifications should not be understood individually from the technical concept and prospect of the present invention.

What is claimed is:

1. A mobile terminal, comprising:
a wireless communication unit configured to receive a first document written using a markup language from a server;
a display unit; and
a controller configured to:
identify a hyperlink tag from at least one tag contained in the first document,
generate a voice keyword for the hyperlink tag, the voice keyword to be used to access a second document associated with the hyperlink tag via a voice command, and
control the display unit to display the voice keyword along with the first document.

2. The mobile terminal of claim 1, further comprising:
a microphone configured to receive a voice command corresponding to the voice keyword,
wherein when the voice command corresponding to the voice keyword is received via the microphone, the controller retrieves the second document using the hyperlink tag corresponding to the voice keyword, and displays the retrieved second document on the display unit.

3. The mobile terminal of claim 2, wherein the controller generates the voice keyword based on a content representing the hyperlink tag.

4. The mobile terminal of claim 3, wherein when the content representing the hyperlink tag contains a text, the controller generates the voice keyword using the text in the content.

5. The mobile terminal of claim 3, wherein when the content representing the hyperlink tag does not contain any text, the controller checks if a description of the content contained in a tag of the content exists, and generates the voice keyword using the description of the content when the description of the content exists.

6. The mobile terminal of claim 5, wherein the description of the content is information stated in at least one of alt and title attributes of the tag of the content.

7. The mobile terminal of claim 3, wherein when the content representing the hyperlink tag does not contain any text and a tag of the content does not contain any description of the content, the controller generates the voice keyword using a number.

8. The mobile terminal of claim 1, wherein the controller displays, on the display unit, a graphic object adjacent to the displayed voice keyword so as to alert a user about a use of a voice command to activate the voice keyword.

9. The mobile terminal of claim 1, wherein the controller generates a data structure containing the voice keyword and a hyperlink of the second document in association with the voice keyword.

10. The mobile terminal of claim 9, wherein the data structure is a hash table in which the voice keyword is configured with a key, and the hyperlink is configured with a hash value.

11. The mobile terminal of claim 1, wherein when the display unit displays the voice keyword along with the first document, the controller is further configured to automatically place the mobile terminal into a voice command recognition mode for recognizing a voice command for the voice keyword.

12. The mobile terminal of claim 1, wherein when the controller identifies the hyperlink tag from that at least one tag contained in the first document, the controller automatically generates the voice keyword for the hyperlink tag.

13. A method of controlling a mobile terminal, the mobile including a display unit and a wireless communication unit, the method comprising:
receiving, by the wireless communication unit, a first document written using a markup language from a server;
identifying a hyperlink tag from at least one tag contained in the first document;
generating a voice keyword for the hyperlink tag, the voice keyword to be used to access a second document associated with the hyperlink tag via a voice command; and
displaying, on the display unit, the voice keyword along with the first document.

14. The method of claim 13, further comprising:
receiving, via a microphone of the mobile terminal, a voice command corresponding to the voice keyword;
retrieving the second document using the hyperlink tag corresponding to the voice keyword in response to the voice command; and
displaying the retrieved second document on the display unit.

15. The method of claim 14, wherein the generating step generates the voice keyword based on a content representing the hyperlink tag.

16. The method of claim 15, wherein when the content representing the hyperlink tag contains a text, the generating step generates the voice keyword using the text in the content.

17. The method of claim 15, wherein when the content representing the hyperlink tag does not contain any text, the generating step includes:
checking if a description of the content contained in a tag of the content exists, and
generating the voice keyword using the description of the content when the description of the content exists.

18. The method of claim 15, wherein when the content representing the hyperlink tag does not contain any text and a tag of the content does not contain any description of the content, the generating step generates the voice keyword using a number.

19. The method of claim 13, further comprising:
displaying, on the display unit, a graphic object adjacent to the displayed voice keyword so as to alert a user about a use of a voice command to activate the voice keyword.

20. The method of claim 13, further comprising:
generating a data structure containing the voice keyword and a hyperlink of the second document in association with the voice keyword.
